(19) United States
(12) Patent Application Publication
(10) Pub. No.: US 2013/0290173 A1
(43) Pub. Date: Oct. 31, 2013

(54) METHOD, PROCESS AND SYSTEM FOR PROVIDING AND RECEIVING COMPENSATION OR A GRATUITY THROUGH THE INTERNET

(71) Applicant: Jordan Michael Nemeroff, Richboro, PA (US)

(72) Inventor: Jordan Michael Nemeroff, Richboro, PA (US)

(21) Appl. No.: 13/871,486

(22) Filed: Apr. 26, 2013

Related U.S. Application Data
(60) Provisional application No. 61/638,749, filed on Apr. 26, 2012.

(51) Int. Cl. G06Q 20/10

(52) U.S. Cl. CPC G06Q 20/10
USPC 705/39

(57) ABSTRACT

An inventive business method and process operated and presented over the internet and using computer software systems, comprises an interactive compensation transmission, receipt, and accounting system. In a preferred embodiment, the inventive method and process may be used to easily allow internet users to provide or receive compensation, in the form of a gratuity or tip to or from other internet users, in response to information, input or other assistance received over the internet. The inventive method and process may also include and use accounting software and systems to track the gratuities transmitted or received, including who are the sending entities and recipient entities. With additional software, the method and process may permit the users to provide anonymous gratuities; periodic gratuities; and certain other accounting features.

### CROSS REFERENCE TO RELATED APPLICATIONS

This application claims priority to U.S. Provisional Application No. 61/638,749, filed on Apr. 26, 2012, the contents of which are incorporated by reference herein, in their entirety and for all purposes.

### FIELD OF THE INVENTION

The present invention relates generally to methods and systems for easily transferring compensation over a global communications network, and in more particularity, to methods and systems for users to provide and/or receive compensation, in the form of a gratuity or tip, through the internet. The providing and receiving of the gratuity could be in response to providing information or assistance, possibly also obtained or transmitted through the internet.

### BACKGROUND OF THE INVENTION

The use of the internet to research or request information, or to seek advice or input on topics, has grown to the point where the first place that many users go to locate input or answers, is the internet. After receiving or finding desired information, that may be of substantial benefit, enjoyment or entertainment value, the user may wish to offer or provide a “thank you” such as a gratuity or tip to the person who provided the information. Such methods and systems, that are easy to use, and fully integrated with users of the internet are not currently available.

This disclosure provides details about a new concept for providing or receiving compensation, in the form of a monetary gratuity or tip, using the internet. In addition to a description of the process and system of providing and/or receiving an internet tip, this application discloses various exemplary scenarios in which a tip through the internet may be implemented.

The scope of use of the inventive method, process and system is extremely broad because, just as in the non-internet world, people use tipping as form of thanks for service, or as a persuasive tool to obtain better service. Through the internet, the offering of information, assistance, or other input, is the equivalent of service outside of the internet.

### SUMMARY OF THE INVENTION

The inventive methods, processes and systems use real-time computer processors executing particular software, comprises in preferred embodiments, an interactive compensation transmission, receipt, and accounting system. In such a preferred embodiment, the inventive method and process may be used to easily allow internet users to provide or receive compensation, in the form of a gratuity or tip to or from other internet users, in response to information, input or other assistance received over the internet. The inventive method and process may also include and use accounting software and systems to track the gratuities transmitted or received, including who are the sending entities and recipient entities. With additional software, the method and process may permit the users to provide anonymous gratuities; periodic gratuities; and certain other accounting features.

The present invention overcomes the limitations and problems with prior art methods and fulfills the needs described above by providing a method, process and system for readily transmitting a gratuity to an identified user, and having that user's account receive the transmitted gratuity.

More specifically, a preferred embodiment of the present invention is an interactive computerized method for transmitting and receiving a gratuity through the internet, comprising the steps of (a) creating a user account, said user account having a unique identifier, and said user account being associated with a financial account; (b) identifying an intended recipient for a gratuity, said intended recipient also having a user account with an associated financial account; (c) selecting a gratuity amount to be transmitted to said identified recipient; (d) transmitting said selected gratuity amount to said financial account of said intended recipient; (e) deducting said selected gratuity amount from said user account associated financial account; and (f) depositing said selected gratuity amount into said recipient account associated financial account.

A further aspect of the present invention is an internet gratuity transmission system, including at least one computer processor, software, databases, and two-way communications links of said at least one computer processor to the internet, permitting internet users to transmit and/or receive compensation through the internet, wherein the computer software executes the steps of (a) creating a user account, said user account having a unique identifier, and said user account being associated with a financial account; (b) identifying an intended recipient for a gratuity, said intended recipient also having a user account with an associated financial account; (c) selecting a gratuity amount to be transmitted to said identified recipient; (d) transmitting said selected gratuity amount to said financial account of said intended recipient; (e) deducting said selected gratuity amount from said user account associated financial account; and (f) depositing said selected gratuity amount into said recipient account associated financial account.

Other features and advantages of the present invention are described in the following detailed description of the invention, which refers to the accompanying drawings as described herein.

### BRIEF DESCRIPTION OF THE DRAWINGS

The drawings and figures, which form a part of this specification, include the following:

FIG. 1 illustrates an example structure and preferred embodiment of the elements within the system for providing and receiving a gratuity through the internet; and

FIG. 2 illustrates an exemplary embodiment of the method and process flow to create a user account and transmit a gratuity through the internet.

### DETAILED DESCRIPTION OF PREFERRED EMBODIMENTS OF THE INVENTION

The inventive method and system provides the means for presenting or receiving compensation, in the form of a monetary gratuity or tip, using the internet as the distribution medium. The inventive method or process of providing a gratuity through the internet, as described in this application, does not currently exist on the internet. In addition to a description of the process and system of providing and/or receiving an internet tip, this application discloses various exemplary scenarios in which the process for providing a tip through the internet may be implemented.

The scope of use of this system is extremely broad because, just as in the non-internet world, people use tipping as form of “thanks” for service, or as a persuasive tool to obtain better service. Through the internet, the offering of information, assistance, or other input, is the equivalent of service that is offered or provided outside of the internet.

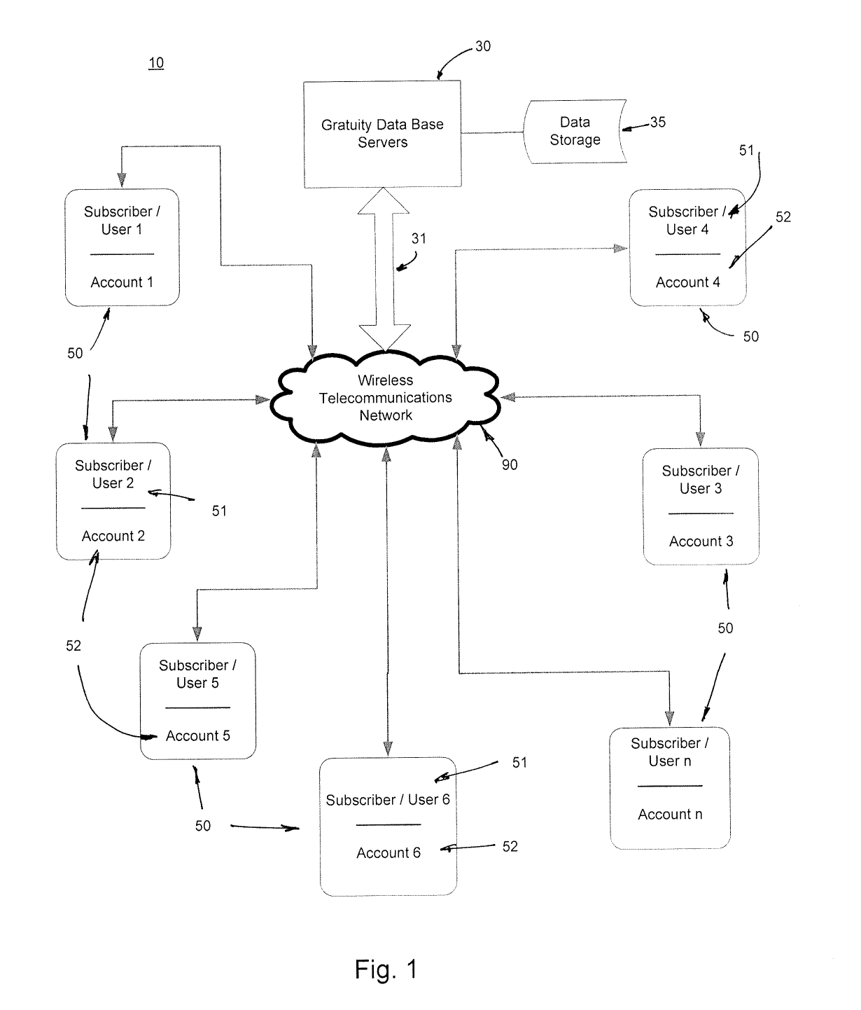

As illustrated in FIG. 1, in a preferred embodiment, the inventive system 10 has several elements. A central server 30, which could also be a plurality of servers 30, is in communicative two-way connection 31 with a global wireless communications network 90, such as the internet. A plurality of users or subscribers 50 are also in communicative two-way connection with the internet 90. As shown in FIG. 1, each subscriber 50 has an associated subscriber or user account 51 along with a monetary account 52 that is the equivalent of a bank account or financial account to hold funds.

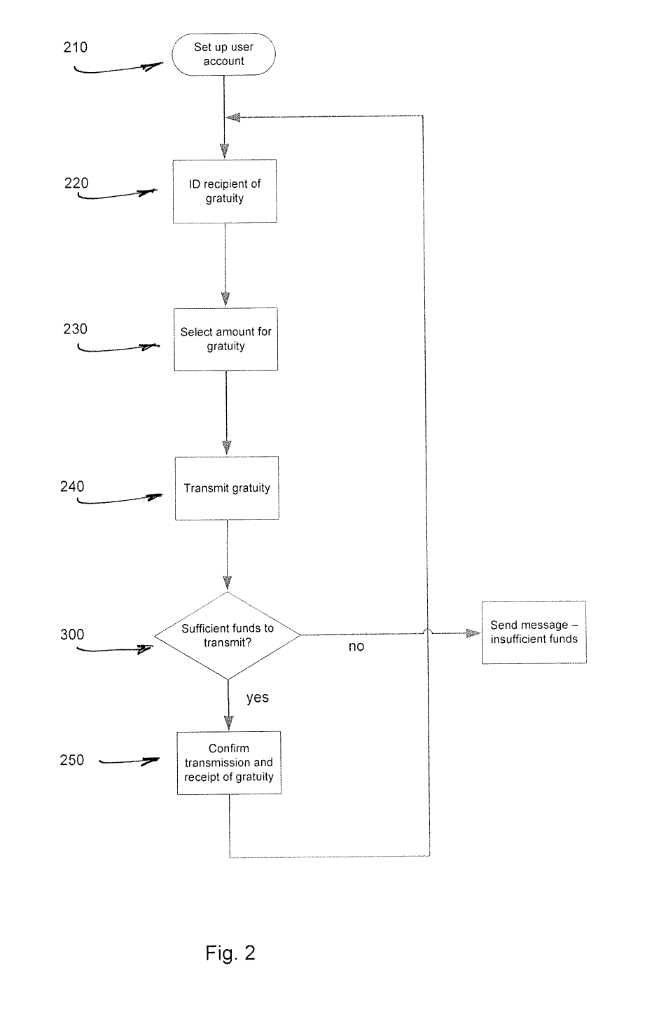

An exemplary embodiment of how the process and system may operate the process is shown in FIG. 2. Each user 50 sets 210 up his or her account 51 and monetary account 52. That process of setting up 210 one's account 51 is similar to how someone can currently set up a Facebook, Twitter, eBay, PayPal or instant messenger account. In that process of setting up 210 one's account 51, the user 50 could identify or create a link or connection to his or her other accounts, including their Facebook, Twitter or PayPal account.

The users' account will be identified with one or more of the users' name, email address, telephone numbers (including a mobile device number), and password. Each user will also be able to use a group name or business name. As either an individual, group, or business, a user could also set up its account to be associated with a particular QR code or similar identifier related to the business or group.

As noted, in a preferred embodiment, the users' account 51 may be directly linked with the users' 50 PayPal or bank account, or similar banking account or banking facility 52. With the creation of the users' account 51, as shown in FIG. 2, each user is in a position to transmit or receive an internet gratuity from any other user 50 who also has created an internet tip account. As shown in FIG. 2, with the creation of one's account 51, a user 50 may identify 220 an intended recipient for a gratuity. The user 50 may decide to send another user 50 a gratuity because the other user has provided information, answered a question, or simply provided something of benefit to the user 50. The user 50 then selects 230 the amount of the gratuity to be transmitted to the recipient, and then approves the transmission 240 of the gratuity to the recipient.

In a preferred embodiment, the system checks 300 the user's bank account 52 to be sure sufficient funds to cover the gratuity are in the user's bank account. If there are insufficient funds, the system 10 can send a message to the user 50 noting that there are insufficient funds to complete the gratuity transmission. If there are sufficient funds in the user's account to complete the transmission, then the system 10 transmits the gratuity to the recipient's account and confirms 250 the transmission and receipt of the gratuity.

In a preferred embodiment, an internet gratuity may be processed (transmitted or received) through any device connected or linked to the internet, including, without limitation, a desktop computer, laptop/netbook, tablet, smart phone, or any other device having an associated internet application.

The following provides particular preferred examples of how the inventive system may be used. An internet user, Person A, that is active through blogging, making informative/entertaining YouTube videos, owning/running a website, leaving reviews or feedback for various products or services, tweeting various information on Twitter, liking something on Facebook, or simply helping someone else through the internet, may immediately be provided with a gratuity or a “thank you” by the recipient of the information, which such recipient(s) could be Persons B through Z, through the transmission of a tip to the account of Person A.

It is important to note that the recipients of the information, Persons B through Z, need not be specifically identified by Person A. Indeed, anyone who sees, retrieves or receives the information provided or broadcast by Person A, may provide an internet tip to Person A. As such, a single posted blog, or posted review on Angie's List® or other web presence may be read and appreciated by many people. Each of those recipients of the post or review may be inclined to provide a gratuity or “thank you” to Person A. As such, Person A has an opportunity to generate income by simply doing what they enjoy doing and were likely doing anyway.

Internet tipping is, in many ways, more effective and better than in-person tipping. Internet tipping alleviates the perceived awkwardness of handing someone money, and eliminates the worry that the recipient may not accept the tip, or wondering if the recipient may be judging you about the amount of the gratuity.

As described above, for the internet tipping system to effectively work, each user 50 must have, and should openly display their “account” username or other identifier (as noted above including one or more of the account name, telephone number, and/or QR code) so that those who wish to provide a tip, will know what information to provide, and where the desired gratuity should be transmitted. Each user 50 has his or her own choice about how to display their respective “account” name. For example, users can display their “account” name in or on any medium, including, but not limited to, individual or organization websites, YouTube postings, Facebook accounts, LinkedIn accounts, advertisements, internet forums, tutorials, marketing material, business cards, magazines, personalized/customized apparel and/or other types of accessories or publications.

As described, the inventive system uses at least one computer processor 30 operating software to manage and record the internet tipping process. The recordation and storage of the internet tipping transaction are maintained in at least one data storage device 35 that is connected to the computer processor, as shown in FIG. 1.

In a preferred embodiment, the software executed by the computer processor may include various accounting algorithms. Such software code would be able to track and record activity for each users' account 51. The tracked activity that would be recorded includes all transmitted and received gratuities, including the time, date, and who is the recipient or sender of the gratuity. The system software may also maintain detailed historical accounting of the tippers' and tipees' information.

In a preferred embodiment, the inventive system does not operate as a bank that would be providing a loan. As described above, each gratuity may only made and transmitted, if there are sufficient funds within the tippers' account. As such, if the account for the tipper does not have sufficient funds, the gratuity will not be transmitted, and the tipper will receive a failure notice that his or her account did not include enough money to transmit the proposed gratuity. The tipper could then attempt to send a smaller gratuity that is appropriately covered by the tipper's account, or could decide to not send a gratuity until his or her account is replenished.

In another preferred embodiment, the method and system will include the option for users to have various settings that may be turned off or on according to the users' choice. By way of example, in a preferred embodiment, a user may set his or her account to be anonymous, such that the tip is being sent or transmitted anonymously.

In still another preferred embodiment of the inventive system and method, a user may set his or her account to auto pay a pre-determined amount to a specific person or person on a pre-determined schedule. For example, a gratuity may be deposited or transmitted on particular holidays, such as Christmas or other holiday or special occasion. According to this preferred embodiment, the user could set a schedule for repeat depositing or transmission of a gratuity. By way of example, other than a special occasion, the frequency could be transmitted each day, week, month, year, or any interval selected by the user.

Similarly, in other preferred embodiments, a user may set predetermined limits on or notifications related to his or her account. By way of example, the user may set a $50 maximum on the amount of any one gratuity. This would prevent the problem of a user mis-typing $500 instead of $5.00 for a gratuity. The system algorithm upon seeing the $500 proposed gratuity, and seeing that is exceeds the $50 limit, would send a message to the user asking something along the lines of “Are you sure you wish to send a $500 gratuity to [identified person]?”

In a related embodiment, the inventive system may be configured to generate automatic notifications to the user 50 if they are approaching or have exceeded set or pre-determined limits. The limits could be an amount for a tip, amounts for tips for that time period (e.g., amounts for a day, week, or month), or could be the number of tips transmitted for that time period (e.g., number of tips deposited for a day, week or month).

The inventive internet tipping system may also include, in a preferred embodiment, an address book or have access to an instant messenger connection, so that the user may easily provide a tip to a specific friend or particular vendor who provided the user with particular information or special service. The inventive system may include software that permits the users to select various “usernames” such that the user may send gratuities under one username to certain recipients, and send other gratuities to other recipients under a different username.

The inventive internet tipping method and system will provide all internet users more incentive to post or provide beneficial information for others to see, use, benefit from, and react to. The inventive internet tipping system provides a streamlined and convenient payment system that is more versatile and user friendly that the current internet systems.

At the present time, there does not appear to be an available method or process to easily provide compensation, in the form of a tip or gratuity, to another person through the internet. Accordingly, the described inventive method and process represents a new and highly valuable tool for users of the internet to provide, and receive, compensation in the form of a tip or gratuity, over the internet in response to providing information, input or assistance to others.

Certain preferred embodiments and examples of the invention have been described herein. It is to be understood that various modifications may be made to these described embodiments without departing from the spirit and scope of the invention. All such modifications and other embodiments are intended to be within the scope of the above description and in the following claims.

While certain exemplary embodiments have been disclosed and described, there are other method and process variations and other system configurations that may provide for a method and system for providing and receiving a gratuity through the internet, that are equally possible and which use the method steps and system elements and architecture as disclosed herein. Such equivalent configurations are deemed fully within the scope of the claimed inventive methods and systems for a method and system for providing and receiving a gratuity through the internet. Those having ordinary skill in the art and access to the teachings provided herein will recognize additional modifications, applications, embodiments and substitution of equivalents all of which are within the scope of the invention. Accordingly, the invention is not to be considered as limited by the foregoing description.

What is claimed is:

1. A computerized method for transmitting and receiving a gratuity through the internet, comprising the steps of:
(a) creating a user account, said user account having a unique identifier, and said user account being associated with a financial account;
(b) identifying an intended recipient for a gratuity, said intended recipient also having a user account with an associated financial account;
(c) selecting a gratuity amount to be transmitted to said identified recipient;
(d) transmitting said selected gratuity amount to said financial account of said intended recipient;
(e) deducting said selected gratuity amount from said user account associated financial account; and
(f) depositing said selected gratuity amount into said recipient account associated financial account.

2. The computerized method for transmitting and receiving a gratuity through the internet, according to claim 1, wherein the gratuity is transmitted anonymously to the recipient.

3. The computerized method for transmitting and receiving a gratuity through the internet, according to claim 1, further comprising step (c1) confirming that sufficient funds are within the associated financial account to transmit the selected gratuity amount.

4. The computerized method for transmitting and receiving a gratuity through the internet, according to claim 1, further comprising steps (c1) comparing the selected gratuity amount to a pre-selected limit; (c2) confirming the selected gratuity amount is less than said pre-select limit.

5. The computerized method for transmitting and receiving a gratuity through the internet, according to claim 1, further comprising steps (c1) comparing the selected gratuity amount to a pre-selected limit for frequency of gratuity transmissions; (c2) confirming the selected gratuity is within said pre-select limit for frequency of gratuity transmissions.

6. The computerized method for transmitting and receiving a gratuity through the internet, according to claim 1, wherein the transmission of the selected gratuity is repeated on a selected schedule.

7. The computerized method for transmitting and receiving a gratuity through the internet, according to claim 1, wherein the transmission of the selected gratuity is automatically transmitted on a pre-determined schedule.

8. The computerized method for transmitting and receiving a gratuity through the internet, according to claim 1, further comprising the steps of recording the transmission and receipt of gratuities using accounting algorithms.

9. An internet gratuity transmission system, including at least one computer processor, software, databases, and two-way communications links of said at least one computer processor to the internet, permitting internet users to transmit and/or receive compensation through the internet, wherein the computer software executes the steps of:
(a) creating a user account, said user account having a unique identifier, and said user account being associated with a financial account;
(b) identifying an intended recipient for a gratuity, said intended recipient also having a user account with an associated financial account;
(c) selecting a gratuity amount to be transmitted to said identified recipient;
(d) transmitting said selected gratuity amount to said financial account of said intended recipient;
(e) deducting said selected gratuity amount from said user account associated financial account; and
(f) depositing said selected gratuity amount into said recipient account associated financial account.

10. The internet gratuity transmission system, including at least one computer processor, software, databases, and two-way communications links of said at least one computer processor to the internet, permitting internet users to transmit and/or receive compensation through the internet, according to claim 9, wherein the gratuity is transmitted anonymously to the recipient.

11. The internet gratuity transmission system, including at least one computer processor, software, databases, and two-way communications links of said at least one computer processor to the internet, permitting internet users to transmit and/or receive compensation through the internet, according to claim 9, further comprising step (c1) confirming that sufficient funds are within the associated financial account to transmit the selected gratuity amount.

12. The internet gratuity transmission system, including at least one computer processor, software, databases, and two-way communications links of said at least one computer processor to the internet, permitting internet users to transmit and/or receive compensation through the internet, according to claim 9, further comprising steps (c1) comparing the selected gratuity amount to a pre-selected limit; (c2) confirming the selected gratuity amount is less than said pre-select limit.

13. The internet gratuity transmission system, including at least one computer processor, software, databases, and two-way communications links of said at least one computer processor to the internet, permitting internet users to transmit and/or receive compensation through the internet, according to claim 9, further comprising steps (c1) comparing the selected gratuity amount to a pre-selected limit for frequency of gratuity transmissions; (c2) confirming the selected gratuity is within said pre-select limit for frequency of gratuity transmissions.

14. The internet gratuity transmission system, including at least one computer processor, software, databases, and two-way communications links of said at least one computer processor to the internet, permitting internet users to transmit and/or receive compensation through the internet, according to claim 9, wherein the transmission of the selected gratuity is repeated on a selected schedule.

15. The internet gratuity transmission system, including at least one computer processor, software, databases, and two-way communications links of said at least one computer processor to the internet, permitting internet users to transmit and/or receive compensation through the internet, according to claim 9, wherein the transmission of the selected gratuity is automatically transmitted on a pre-determined schedule.

16. The internet gratuity transmission system, including at least one computer processor, software, databases, and two-way communications links of said at least one computer processor to the internet, permitting internet users to transmit and/or receive compensation through the internet, according to claim 9, further comprising the steps of recording the transmission and receipt of gratuities using accounting algorithms.
